(19) United States
(12) Patent Application Publication
(10) Pub. No.: US 2010/0138881 A1
(43) Pub. Date: Jun. 3, 2010

(54) SMMD HOME SERVER AND METHOD FOR REALISTIC MEDIA REPRODUCTION

(76) Inventors: Wan Ki PARK, Daejeon (KR); Chang-Sic CHOI, Daejeon (KR); Yong Mun PARK, Daejeon (KR); Hae Ryong LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/533,051

(22) Filed: Jul. 31, 2009

(30) Foreign Application Priority Data
Dec. 2, 2008 (KR) 10-2008-0121019
Apr. 6, 2009 (KR) 10-2009-0029320

(51) Int. Cl. H04N 7/18; H04N 5/00

(52) U.S. Cl. 725/82; 386/125; 386/E05.003

(57) ABSTRACT

A single-media multi-devices (SMMD) home server includes a plurality of media decoding units decoding multi-channel AV media data divided from a realistic media content and reproducing the decoded multi-channel AV media data; a home server processor unit dividing the realistic media content into the multi-channel AV media data and effects data, feeding the divided multi-channel AV media data to the media decoding units, and generating effects control data corresponding to the divided effects data; and a gateway/Ethernet switch receiving the realistic media content through a network and forwarding the received realistic media content to the home server processor unit, and receiving the divided multi-channel AV media data from the home server processor unit and feeding the received multi-channel AV media data to the media decoding units through a switching function.

### CROSS-REFERENCE(S) TO RELATED APPLICATIONS

The present invention claims priority of Korean Patent Application No. 10-2008-0121019, filed on Dec. 2, 2008, and No. 10-2009-0029320, filed on Apr. 6, 2009 which are incorporated herein by reference.

### FIELD OF THE INVENTION

The present invention relates to a media reproduction system and, more particularly, to an SMMD home server that can effectively handle realistic media composed of multi-channel video image, audio, text, and effects data maximizing media effects with a single-media multi-devices (SMMD) based system where a single media content can be reproduced through synchronized multi-channel video image and multiple devices, and to a media reproduction method for the same.

### BACKGROUND OF THE INVENTION

Various multimedia contents, which have been developed mainly on the basis of audio and video technologies, enable users to enjoy more realistic or sensory media environments along with recent development of multi-channel audio and ultra high definition video.

For media reproduction with a realistic sensation, it is necessary to provide an SMMD-based service in which stereoscopic images including two or more video items or realistic media including multi-channel video, audio, text, and effects data can be reproduced through multiple synchronized devices.

Currently, most conservative media services are a single-media single-device (SMSD) service in which a single media content is reproduced through a single device, and thus SMMD-based reproduction of realistic media such as multi-channel video images, requiring synchronized operation of multiple devices, is not actively utilized.

### SUMMARY OF THE INVENTION

It is, therefore, an object of the present invention to provide an SMMD home server that can effectively handle realistic media composed of multi-channel video, audio, text, and effects data maximizing media effects in an SMMD-based system where a single media content can be reproduced through multiple synchronized devices, and to provide a media reproduction method for the SMMD home server.

In accordance with an aspect of the present invention, there is provided a single-media multi-devices (SMMD) home server including a plurality of media decoding units decoding multi-channel AV media data divided from a realistic media content and reproducing the decoded multi-channel AV media data; a home server processor unit dividing the realistic media content into the multi-channel AV media data and effects data, feeding the divided multi-channel AV media data to the media decoding units, and generating effects control data corresponding to the divided effects data; and a gateway/Ethernet switch receiving the realistic media content through a network and forwarding the received realistic media content to the home server processor unit, and receiving the divided multi-channel AV media data from the home server processor unit and feeding the received multi-channel AV media data to the media decoding units through a switching function.

It is preferable that the home server processor unit includes a data interface section receiving the realistic media content, and sending the multi-channel AV media data divided from the realistic media content to the gateway/Ethernet switch; a media processing section dividing the realistic media content into the multi-channel AV media data and the effects data; a device managing section generating the effects control data corresponding to the divided effects data, and feeding the effects control data to effects generation devices; a browser section generating a browser screen helping a user select the realistic media content; and a browser screen generator providing the browser screen generated by the browser section to a selected one of the media decoding units as a screen input.

It is preferable that the data interface section receives the realistic media content from the gateway/Ethernet switch or from a local storage.

It is preferable that the data interface section includes a disk interface reading the realistic media content from the local storage, and sending the read realistic media content to the media processing section; and an Ethernet interface providing the realistic media content received from the gateway/Ethernet switch to the media processing section, and sending back to the gateway/Ethernet switch the multi-channel AV media data divided from the realistic media content by the media processing section.

It is preferable that the media processing section includes a media track analyzer/separator analyzing the realistic media content from the data interface section to divide the realistic media content into the multi-channel AV media data and the effects data; a neo-data analyzer analyzing the effects data to generate the effects control data for generation of effects corresponding to reproduction of the multi-channel AV media data; and a synchronization manager creating and managing synchronization information for the reproduction of the multi-channel AV media data.

It is preferable that the device managing section includes device controllers controlling the effects generation devices based on the effects control data; and a device search/profile manager storing information regarding the effects generation devices.

It is preferable that the home server processor unit communicates with the media decoding units through an inter-processor communication (IPC) channel.

It is preferable that each media decoding unit includes: an Ethernet interface receiving the multi-channel AV media data from the gateway/Ethernet switch; an AV media buffer storing the multi-channel AV media data; a synchronization controller/manager synchronizing the audio/video reproduced by the media decoding unit to the effects controlled by the home server processor unit and supplying synchronization information for the multi-channel AV media data to the AV media buffer; an AV media controller synchronizing the multi-channel AV media data based on the synchronization information and then allowing the AV media buffer to store the multichannel AV media data therein; and an AV media decoder decoding the multi-channel AV media data under the control of the AV media controller.

It is preferable that the realistic media content is multi-channel media data containing two or more video channels.

In accordance with another aspect of the invention, there is provided a method of realistic media content reproduction in an SMMD home server including dividing, in response to a request for reproduction of a realistic media content, the realistic media content into multi-channel AV media data and effects data; sending the multi-channel AV media data and synchronization information to media decoding units to decode the multi-channel AV media data; generating effects control data for controlling effects generation devices to generate media effects based on the effects data; and reproducing the decoded multi-channel AV media data while generating the media effects corresponding the multi-channel AV media data based on the effects control data.

It is preferable that the realistic media content is received through a network from a remote SMMD media server.

It is preferable that the realistic media content is received from a local storage.

It is preferable that the multi-channel AV media data is decoded by each of the media decoding unit, a number of the media decoding units corresponding to a number of the multi-channel AV media data in each of the realistic media content.

It is preferable that the realistic media content is multi-channel media data containing two or more video channels.

In a feature of the present invention, an SMMD home server is provided that is capable of processing realistic media including multi-channel video, audio, text, and effects data maximizing media effects. The SMMD home server permits local or remote realistic media contents to be reproduced through multiple effects generation devices in a synchronized manner according to the effects data in the realistic media contents, such that more realistic images can be reproduced. Reproduction of realistic media including multi-channel video, audio, text and including effects data using the SMMD home server can enhance the sensation of reality.

### BRIEF DESCRIPTION OF THE DRAWINGS

The above and other objects and features of the present invention will become apparent from the following description of embodiments given in conjunction with the accompanying drawings, in which:

FIG. 1A is a block diagram of an SMMD media server in accordance with an embodiment of the present invention;

FIG. 1B is a block diagram of an SMMD home server in accordance with an embodiment of the present invention;

FIG. 2 is a detailed block diagram of a home server processor unit in the SMMD home server of FIG. 1B;

FIG. 3 is a detailed block diagram of a media decoding unit in the SMMD home server of FIG. 1B;

FIG. 4 is a flow chart illustrating a procedure of reproducing local realistic media performed by the SMMD home server; and

FIG. 5 is a flow chart illustrating a procedure of reproducing remote realistic media performed by the SMMD home server.

### DETAILED DESCRIPTION OF THE EMBODIMENTS

Hereinafter, embodiments of the present invention will be described in detail with reference to the accompanying drawings so that they can be readily implemented by those skilled in the art.

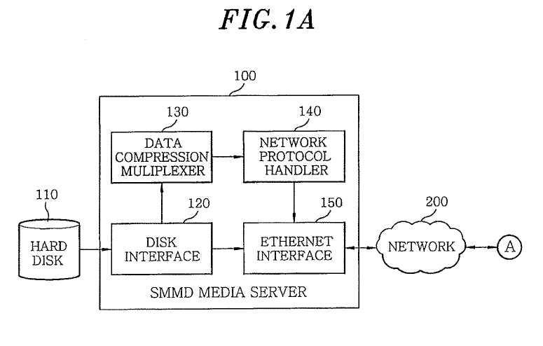

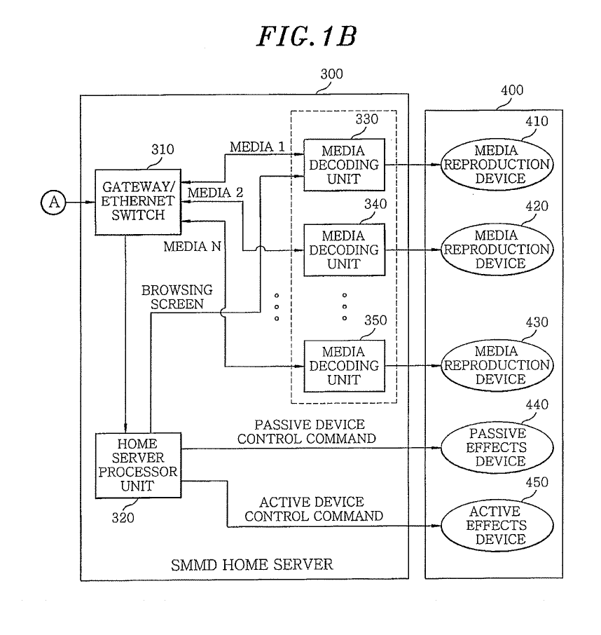

FIGS. 1A and 1B illustrate an SMMD media server 100 and SMMD home server 300 connected through a network 200 for remote media reproduction in accordance with the embodiments of the present invention.

The SMMD media server 100 supplies realistic media to the SMMD home server 300. The realistic media, referred to as ne-media (‘ne’ for new or neo), have a newly designed format, and can be composed of two or more audio/video items, text, and effects data. The SMMD media server 100 includes a hard disk 110 storing realistic media data, a disk interface 120, a data compression multiplexer 130, a network protocol handler 140, and an Ethernet interface 150.

The disk interface 120 reads realistic media data of a selected media file from the hard disk 110 compressed in, for example, the MPEG-4 format. Here, the realistic media data may include multiple audio/video items, text data, and effects data. The DATA COMPRESSION MULIPLEXER 130 converts the read media file data into a format for transmission. The network protocol handler 140 transmits the converted media data through the Ethernet interface 150 to the network 200.

The SMMD home server 300 receives realistic media data through the network 200 from the SMMD media server 100, decodes the received realistic media data, and then reproduces (displays) the decoded realistic media data through various audio/visual (AV) devices. The SMMD home server 300 includes a gateway/Ethernet switch 310, a home server processor unit 320, media decoding units 330, 340 and 350, and a device unit 400 for AV media reproduction.

The gateway/Ethernet switch 310 is connected through the network 200 to the SMMD media server 100 to receive realistic media data therefrom and forwards the received realistic media data to the home server processor unit 320, which then divides the realistic media data into AV media data and effects data. The gateway/Ethernet switch 310 receives the divided AV media data from the home server processor unit 320, and supplies the AV media data to the media decoding units 330, 340 and 350 through a switching function.

The number of media decoding units 330, 340 and 350 corresponds to the number of AV media items, and each of the media decoding units 330, 340 and 350 decodes one of AV media items divided from realistic media data to send the decoded AV media item to a corresponding one of media reproduction devices 410, 420 and 430 in the device unit 400. The device unit 400 includes the media reproduction devices 410, 420 and 430 connected respectively to the media decoding units 330, 340 and 350, and further includes a passive effects device 440 and active effects device 450 for generating media effects under the control of the home server processor unit 320.

The home server processor unit 320 divides received realistic media data into AV data and effects data, controls the operation of each component, and, in particular, controls the passive effects device 440 and active effects device 450 in the device unit 400 to generate special effects with the divided effects data. The home server processor unit 320 can receive realistic media data through the network 200 from the remote SMMD media server 100, or from a local hard disk directly attached to the home server processor unit 320.

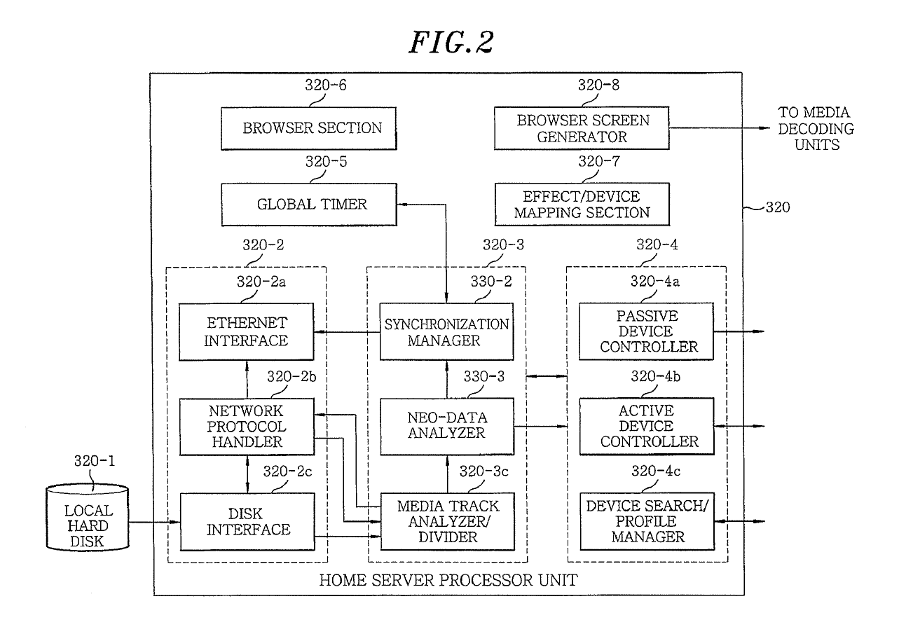

FIG. 2 is a detailed block diagram of the home server processor unit 320 in the SMMD home server 300.

The home server processor unit 320 includes a data interface section 320-2, media processing section 320-3, device managing section 320-4, global timer 320-5, browser section 320-6, effect/device mapping section 320-7, and browser screen generator 320-8.

The data interface section 320-2 receives realistic media data through the gateway/Ethernet switch 310 remotely from the SMMD media server 100 and forwards the received realistic media data to the media processing section 320-3, and sends divided multi-channel AV media data from the media processing section 320-3 to the media decoding units 330, 340 and 350.

In the data interface section 320-2, an Ethernet interface 320-2a receives realistic media data from the gateway/Ethernet switch 310, and a disk interface 320-2c reads realistic media data stored in a local hard disk 320-1.

Realistic media data is sent to the media processing section 320-3, and is divided into AV media data and effects data. Multiple AV media items divided from the realistic media data are sent by the network protocol handler 320-2b and Ethernet interface 320-2a to the gateway/Ethernet switch 310, which then forwards the multiple AV media items to the media decoding units 330, 340 and 350.

In the media processing section 320-3, a media track analyzer/separator 320-3c divides realistic media data into multiple AV media items to send the AV media items to the network protocol handler 320-2b, and the effects data to a neo-data analyzer 320-3b. The neo-data analyzer 320-3b receives effects data from the media track analyzer/separator 320-3c, and generates effects control data for effect generation devices to send the effects control data to the device managing section 320-4.

In the device managing section 320-4, effects control data from the neo-data analyzer 320-3b is fed to a passive device controller 320-4a or active device controller 320-4b. To generate effects according to the effects control data, the passive device controller 320-4a controls the passive effects device 440 and the active device controller 320-4b controls the active effects device 450. A device search/profile manager 320-4c manages automatic enrolment and attribute information of the passive effects device 440 and active effects device 450, and provides information regarding the passive effects device 440 and active effects device 450 to the passive device controller 320-4a and the active device controller 320-4b for device control.

The browser section 320-6 generates a browser screen to receive a user selection for realistic media reproduction. The global timer 320-5 and synchronization manager 320-3a of the media processing section 320-3 synchronize the home server processor unit 320 to the media decoding units 330, 340 and 350 in time for cooperation. The effect/device mapping section 320-7 matches the media reproduction devices 410, 420 and 430 with operations of the passive effects device 440 or active effects device 450 during AV media reproduction. The browser screen generator 320-8 creates a browser screen for controlling and making screen transitions.

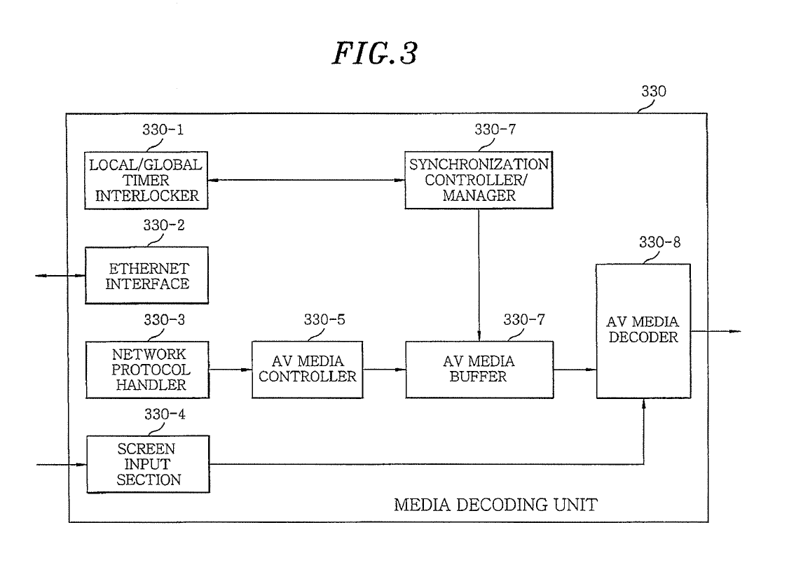

FIG. 3 is a detailed block diagram of the media decoding unit 330 in the SMMD home server 300. The media decoding unit 330 includes a local/global timer interlocker 330-1, Ethernet interface 330-2, network protocol handler 330-3, screen input section 330-4, AV media controller 330-5, AV media buffer 330-6, synchronization controller/manager 330-7, and AV media decoder 330-8.

The Ethernet interface 330-2 receives multiple separated AV media items through the gateway/Ethernet switch 310. The network protocol handler 330-3 sends AV media data from the Ethernet interface 330-2 to the AV media controller 330-5 after suitable protocol processing. The AV media controller 330-5 stores the AV media data in the AV media buffer 330-6. The AV media decoder 330-8 decodes the AV media data stored in the AV media buffer 330-6 and reproduces the decoded AV media data on the screen.

The synchronization controller/manager 330-7 synchronizes the audio/video reproduced by the media decoding units 330, 340 and 350 to the effects controlled by the home server processor unit 320 through the local/global timer interlocker 330-1, and supplies the synchronization information received from the home server processor unit 320 to the AV media buffer 330-6 for synchronization of AV media data from the gateway/Ethernet switch 310. The screen input section 330-4 receives browser screen data from the home server processor unit 320 and sends the browser screen data to the AV media decoder 330-8.

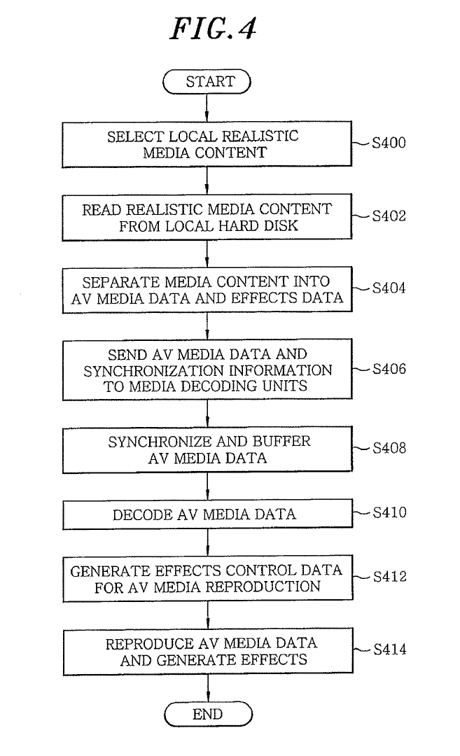

FIG. 4 is a flow chart illustrating a procedure of reproducing local media performed by the SMMD home server 300. An embodiment of a realistic media reproduction method is described below with reference to FIGS. 1 to 4.

Referring to FIG. 4, when the user selects, for reproduction, a realistic media content stored in the local hard disk 320-1 of the SMMD home server 300 through a media reproduction browser screen generated by the home server processor unit 320 (S400), data of the selected realistic media content is read from the local hard disk 320-1 through the disk interface 320-2c of the home server processor unit 320 (S402).

The realistic media data read from the local hard disk 320-1 is sent through the disk interface 320-2c to the media track analyzer/divider 320-3c, and is divided by the media track analyzer/separator 320-3c into multiple AV media items and effects data (S404).

The multiple AV media items divided by the media track analyzer/separator 320-3c are transmitted through the network protocol handler 320-2b and Ethernet interface 320-2a to the gateway/Ethernet switch 310, and are forwarded by the switching function of the gateway/Ethernet switch 310 to the media decoding units 330, 340 and 350 (S406). Here, synchronization information for AV media reproduction is also transmitted through the synchronization manager 320-3a to the media decoding units 330, 340 and 350. Transmission of media file data from the Ethernet interface 320-2a to the media decoding units 330, 340 and 350 is performed through an inter-processor communication (IPC) channel.

The AV media items from the gateway/Ethernet switch 310 are sent through the Ethernet interfaces 330-2 of the media decoding units 330, 340 and 350 to the AV media buffers 330-6, which store the received AV media items, respectively, and the synchronization information is fed to the local/global timer interlockers 330-1 and the synchronization controller/managers 330-7 for AV media reproduction synchronization (S408).

In each of the media decoding units 330, 340 and 350, the AV media item stored in the AV media buffer 330-6 is decoded by the AV media decoder 330-8 (S410).

The effects data divided by the media track analyzer/separator 320-3c is sent to the neo-data analyzer 320-3b, which then generates effects control data to control the passive effects device 440 and active effects device 450 in generation of media effects during AV media reproduction (S412).

The generated effects control data is sent through the passive device controller 320-4a of the device managing section 320-4 to the passive effects device 440 of the device unit 400 or through the active device controller 320-4b to the active effects device 450, and media effects are generated by the passive effects device 440 or active effects device 450 when the decoded AV media items from the media decoding units 330, 340 and 350 are reproduced through the media reproduction devices 410, 420 and 430 of the device unit 400 (S414).

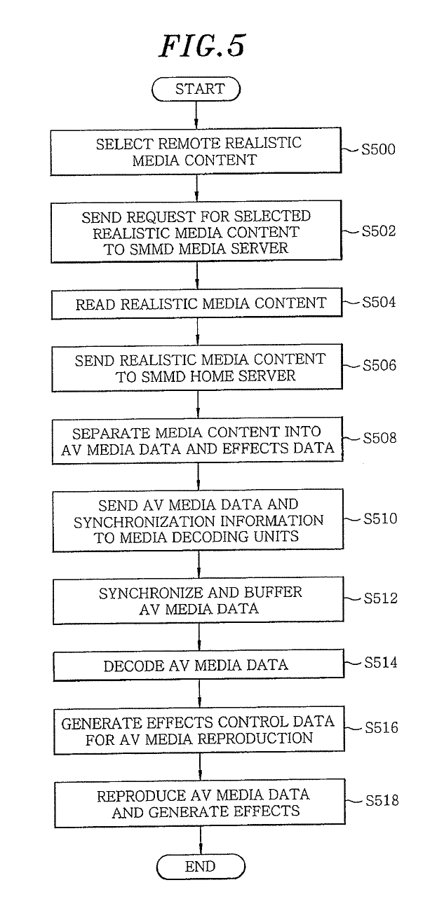

FIG. 5 is a flow chart illustrating a procedure of reproducing remote media performed by the SMMD home server 300. Another embodiment of a realistic media reproduction method is described below with reference to FIGS. 1 to 3, and 5.

When the user selects, for reproduction, a realistic media content stored in the hard disk 110 of the remote SMMD media server 100 through a media reproduction browser screen generated by the home server processor unit 320 (S500), the SMMD home server 300 sends a request for the selected realistic media content to the SMMD media server 100 (S502).

In response to the request, data of the requested realistic media content is read from the hard disk 110 through the disk interface 120 of the SMMD media server 100 (S504), and the read realistic media data is sent through the network protocol handler 140 and Ethernet interface 150 to the SMMD home server 300 (S506).

At the SMMD home server 300, the realistic media data is forwarded through the gateway/Ethernet switch 310 to the home server processor unit 320.

At the home server processor unit 320, the realistic media data is forwarded through the Ethernet interface 320-2a to the media track analyzer/divider 320-3c, and is divided by the media track analyzer/separator 320-3c into multiple AV media items and effects data (S508).

The multiple AV media items divided by the media track analyzer/separator 320-3c are transmitted through the network protocol handler 320-2b and Ethernet interface 320-2a to the gateway/Ethernet switch 310, and are forwarded by the switching function of the gateway/Ethernet switch 310 to the media decoding units 330, 340 and 350 (S510). Here, synchronization information for AV media reproduction is also transmitted through the synchronization manager 320-3a to the media decoding units 330, 340 and 350. Transmission of media file data from the Ethernet interface 320-2a to the media decoding units 330, 340 and 350 is performed through an inter-processor communication (IPC) channel.

The AV media items from the gateway/Ethernet switch 310 are sent through the Ethernet interfaces 330-2 of the media decoding units 330, 340 and 350 to the AV media buffers 330-6, which store the received AV media items, respectively, and the synchronization information is fed to the local/global timer interlockers 330-1 and the synchronization controller/managers 330-7 for AV media reproduction synchronization (S512).

In each of the media decoding units 330, 340 and 350, the AV media item stored in the AV media buffer 330-6 is decoded by the AV media decoder 330-8 (S514).

The effects data divided by the media track analyzer/divider 320-3c is sent to the neo-data analyzer 320-3b, which then generates effects control data to control the passive effects device 440 and active effects device 450 in generation of media effects during AV media reproduction (S516).

The generated effects control data is sent through the passive device controller 320-4a of the device managing section 320-4 to the passive effects device 440 of the device unit 400 or through the active device controller 320-4b to the active effects device 450, and media effects are generated by the passive effects device 440 or active effects device 450 when the decoded AV media items from the media decoding units 330, 340 and 350 are reproduced through the media reproduction devices 410, 420 and 430 of the device unit 400 (S518).

As described above, the SMMD home server of the present invention is capable of processing realistic media including multi-channel video, audio, text, and effects data maximizing presentation effects. The SMMD home server permits local or remote realistic media contents to be reproduced through multiple effects generation devices in a synchronized manner according to the included effects data, enabling reproduction of more realistic images. The SMMD home server can also enhance the sensation of reality by reproducing realistic media including multi-channel video, audio and text.

While the invention has been shown and described with respect to the preferred embodiments, it will be understood by those skilled in the art that various changes and modifications may be made without departing from the spirit and scope of the invention as defined in the following claims.

What is claimed is:

1. A single-media multi-devices (SMMD) home server, comprising:
a plurality of media decoding units decoding multi-channel AV media data divided from a realistic media content and reproducing the decoded multi-channel AV media data;
a home server processor unit dividing the realistic media content into the multi-channel AV media data and effects data, feeding the divided multi-channel AV media data to the media decoding units, and generating effects control data corresponding to the divided effects data; and
a gateway/Ethernet switch receiving the realistic media content through a network and forwarding the received realistic media content to the home server processor unit, and receiving the divided multi-channel AV media data from the home server processor unit and feeding the received multi-channel AV media data to the media decoding units through a switching function.

2. The SMMD home server of claim 1, wherein the home server processor unit comprises:
a data interface section receiving the realistic media content, and sending the multi-channel AV media data divided from the realistic media content to the gateway/Ethernet switch;
a media processing section dividing the realistic media content into the multi-channel AV media data and the effects data;
a device managing section generating the effects control data corresponding to the divided effects data, and feeding the effects control data to effects generation devices;
a browser section generating a browser screen helping a user select the realistic media content; and
a browser screen generator providing the browser screen generated by the browser section to a selected one of the media decoding units as a screen input.

3. The SMMD home server of claim 2, wherein the data interface section receives the realistic media content from the gateway/Ethernet switch or from a local storage.

4. The SMMD home server of claim 2, wherein the data interface section comprises:
a disk interface reading the realistic media content from the local storage, and sending the read realistic media content to the media processing section; and
an Ethernet interface providing the realistic media content received from the gateway/Ethernet switch to the media processing section, and sending back to the gateway/Ethernet switch the multi-channel AV media data divided from the realistic media content by the media processing section.

5. The SMMD home server of claim 2, wherein the media processing section comprises:
a media track analyzer/separator analyzing the realistic media content from the data interface section to divide the realistic media content into the multi-channel AV media data and the effects data;
a neo-data analyzer analyzing the effects data to generate the effects control data for generation of effects corresponding to reproduction of the multi-channel AV media data; and
a synchronization manager creating and managing synchronization information for the reproduction of the multi-channel AV media data.

6. The SMMD home server of claim 2, wherein the device managing section comprises:
device controllers controlling the effects generation devices based on the effects control data; and
a device search/profile manager storing information regarding the effects generation devices.

7. The SMMD home server of claim 1, wherein the home server processor unit communicates with the media decoding units through an inter-processor communication (IPC) channel.

8. The SMMD home server of claim 1, wherein each media decoding unit comprises:
an Ethernet interface receiving the multi-channel AV media data from the gateway/Ethernet switch;
an AV media buffer storing the multi-channel AV media data;
a synchronization controller/manager synchronizing the audio/video reproduced by the media decoding unit to the effects controlled by the home server processor unit and supplying synchronization information for the multi-channel AV media data to the AV media buffer;
an AV media controller synchronizing the multi-channel AV media data based on the synchronization information and then allowing the AV media buffer to store the multichannel AV media data therein; and
an AV media decoder decoding the multi-channel AV media data under the control of the AV media controller.

9. The SMMD home server of claim 1, wherein the realistic media content is multi-channel media data containing two or more video channels.

10. A method of realistic media content reproduction in an SMMD home server, comprising:
dividing, in response to a request for reproduction of a realistic media content, the realistic media content into multi-channel AV media data and effects data;
sending the multi-channel AV media data and synchronization information to media decoding units to decode the multi-channel AV media data;
generating effects control data for controlling effects generation devices to generate media effects based on the effects data; and
reproducing the decoded multi-channel AV media data while generating the media effects corresponding the multi-channel AV media data based on the effects control data.

11. The method of claim 10, wherein the realistic media content is received through a network from a remote SMMD media server.

12. The method of claim 10, wherein the realistic media content is received from a local storage.

13. The method of claim 10, wherein the multi-channel AV media data is decoded by each of the media decoding unit, a number of the media decoding units corresponding to a number of the multi-channel AV media data in each of the realistic media content.

14. The method of claim 10, wherein the realistic media content is multi-channel media data containing two or more video channels.
